(19) United States
(12) Patent Application Publication
(10) Pub. No.: US 2025/0392232 A1
(43) Pub. Date: Dec. 25, 2025

(54) THREE PHASE TO SINGLE PHASE POWER SUPPLY EQUIPMENT

(71) Applicant: BorgWarner Inc., Auburn Hills, MI (US)

(72) Inventors: Luca Di Carlo, Royal Oak, MI (US); Rakesh Anil Kumar Nair, West Bloomfield, MI (US)

(21) Appl. No.: 18/753,325

(22) Filed: Jun. 25, 2024

(51) Int. Cl. H02M 7/219; B60L 53/10

(52) U.S. Cl. CPC H02M 7/219; B60L 53/11; B60L 2210/12; B60L 2210/14

(57) ABSTRACT

A method of controlling power supply equipment that includes receiving alternating current (AC) electrical power at the power supply equipment; selecting a mode from the following possible modes: high power buck, high power boost, low power buck, or low power boost; generating gate signals based on the selected mode; and providing the generated gate signals to switches included in the power supply equipment that rectify alternating current (AC) into direct current (DC).

### GOVERNMENT INTEREST

This invention was made with government support under the DE-EE0009869 contract, awarded by the United States Department of Energy, Energy Efficiency & Renewable Energy EE-1 Office. The U.S. Government has certain rights in the invention.

### TECHNICAL FIELD

The present application relates to power supply equipment and, more particularly, to three phase to single phase power supply equipment.

### BACKGROUND

Power supply equipment can be used to convert electrical power existing in one form, such as alternating current (AC) into another form, such as direct current (DC). Converting the electrical power input to the power supply equipment into another form can involve inefficiencies that may reduce the conversion of the electrical power from one form to another. It would be helpful to minimize the inefficiencies that exist in the power supply equipment.

### SUMMARY

In one implementation, a method of controlling power supply equipment includes receiving alternating current (AC) electrical power at the power supply equipment; selecting a mode from the following possible modes: high power buck, high power boost, low power buck, or low power boost; generating gate signals based on the selected mode; and providing the generated gate signals to switches included in the power supply equipment that rectify alternating current (AC) into direct current (DC).

In another implementation, a method of controlling power supply equipment includes receiving alternating current (AC) electrical power at a primary circuit that is electrically coupled to a primary wire of a transformer; determining a gain value; determining an operating curve based on the gain value; selecting a mode from the following possible modes: high power buck, high power boost, low power buck, or low power boost using an AC voltage value input at the primary circuit; and controlling a secondary group of switches based on the selected mode.

In yet another implementation, a control system for controlling power supply equipment has a plurality of switches included with the power supply equipment; and one or more microprocessors, including memory storing computer executable instructions, such that the one or more microprocessors are configured to control the plurality of switches to receive alternating current (AC) electrical power at the power supply equipment; select a mode from the following possible modes: high power buck, high power boost, low power buck, or low power boost; generate gate signals based on the selected mode; and provide the generated gate signals to the switches that rectify alternating current (AC) into direct current (DC).

### BRIEF DESCRIPTION OF THE DRAWINGS

FIG. 1 is a block diagram depicting an implementation of an electrical system using power supply equipment;

FIG. 2 is a circuit diagram depicting an implementation of power supply equipment;

FIG. 3 is a flow chart depicting an implementation of a method of controlling the power supply equipment;

FIG. 4 is another flow chart depicting an implementation of a method of controlling the power supply equipment;

FIG. 5 is a graph depicting an implementation of a method of controlling the power supply equipment;

FIG. 6 is another graph depicting an implementation of a method of controlling the power supply equipment;

FIG. 7 is another graph depicting an implementation of a method of controlling the power supply equipment; and

FIG. 8 is another graph depicting an implementation of a method of controlling the power supply equipment.

### DETAILED DESCRIPTION

Three phase to single phase power supply equipment can receive three-phase alternating current (AC) electrical power and convert the three-phase AC electrical power to single phase AC electrical power. The power supply equipment can include a matrix converter including a primary group of switches and a secondary group of switches electrically coupled via a transformer. The power supply equipment could be implemented as an indirect matrix converter used in a stationary vehicle battery charger that converts three-phase AC to single-phase AC and, ultimately, to direct current (DC) electrical power that can be applied to a battery.

Current control systems used with power supply equipment can use State Vector Modulation (SVM) to generate gate signals received by the primary group of switches. Control of the secondary group of switches may be phase shifted with respect to the primary group by a variable angle defined by a requested set point. This control strategy can generate increased amounts of unwanted circulatory current if the system operates at a value different from unity gain (K)

$$( K = \frac{Vin}{n * Vout} ) .$$

At unity gain K=1, and n represents the transformer number of turns ratio. The circulatory current can create a reactive power problem that may significantly reduce the efficiency of the power supply equipment when the voltage gain is not unity. Reactive power does not transfer energy but produces conduction losses in power devices and transformer.

In contrast, control of the secondary group of switches can reduce the circulatory current. For example, control of the secondary group of switches can be divided into, and governed by, four control modes: high power buck, low power buck, high power boost, and low power boost—depending on the ratio of input voltage to output voltage and gain (K). As the battery is charged in a constant current mode, battery voltage may continuously increase along with the power delivered. Given this relationship, a selection of modulation strategy can depend on an operating point in the output voltage versus power curve. Similarly, in constant voltage mode, the power delivered may decrease as the flow of electrical current decreases. As a result, during the power module operation, the control strategy can be switched during operation based on an operational curve related to voltage/power. The control strategy can involve control of the duty cycle of a secondary group of switches as well as control of the phase shift between the secondary group of switches and the primary group of switches. The control strategy can introduce three degrees of freedom: duty cycle control of the primary group of switches, phase shift control of the secondary group of switches relative to the primary group of switches, and duty cycle control of the secondary group of switches. The primary group of switches can be controlled using Space Vector Modulation (SVM). The control can be fed forward along with zero crossing inductor current information (feedback) for duty cycle control of the secondary group of switches and phase shift control of secondary group of switches with respect to the primary group of switches. The control strategy can be influenced based on output voltage and output power.

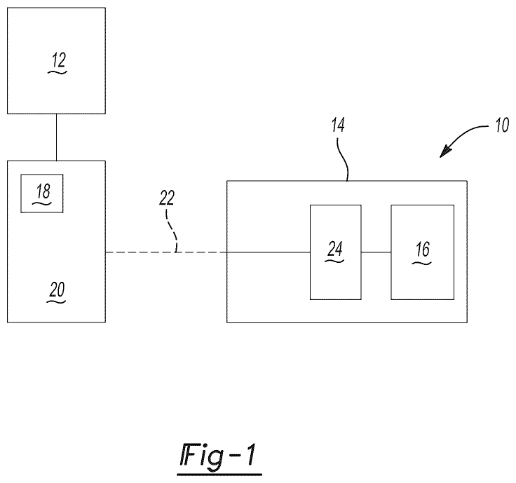

FIG. 1 depicts an implementation of an electrical system 10 including an implementation of the power supply equipment and the control system. The methods of control used with the power supply equipment can be used with the electrical system 10. The system 10 includes an electrical grid 12 and a battery electric vehicle (BEV) 14 that can receive electrical power from the grid 12. The electrical grid 12 can include any one of a number of electrical power generators and electrical delivery mechanisms. Electrical generators (not shown) create AC electrical power that can then be transmitted a significant distance away from the electrical generator for residential and commercial use. The electrical generator can couple with the electrical grid 12 that transmits the AC electrical power from the electrical generator to an end user, such as a residence or business.

The BEV 14 includes one or more rotating electrical machines 16 (also referred to as electric motors) that include a stator having stator windings and a rotor that can be angularly displaced relative to the stator (not shown). In one implementation, the rotating electrical machine 16 is a permanent magnet synchronous electrical machine, which includes a rotor having a plurality of angularly-spaced permanent magnets. The permanent magnets can be made from any one of a number of different materials, one example of which is a neodymium alloy or other rare earth element.

A DC fast charger 20, also referred to as a BEV charging station, can receive AC electrical power from the grid 12 and provide the electrical power to the BEV 14. The DC fast charger 20 is one implementation of power supply equipment. However, other implementations are possible, such as wireless charging and AC charging. The DC fast charger 20 can include an input terminal that receives the AC electrical power from the grid 12, converts the AC electrical power to DC electrical power, and transmits the DC electrical power to a vehicle battery 24 included on the BEV 14. The DC fast charger 20 can include a matrix converter that receives AC electrical power from the electrical grid 12, converts the received AC electrical power from one frequency to another frequency, and then rectifies the AC electrical power into DC electrical power that is supplied to the BEV 14. The DC fast charger 20 can also include a control system 18 regulating the AC electrical power received from the grid 12 that is supplied to a vehicle battery 24.

For example, the control system 18 can comprise electronics including one or more microprocessors including memory storing computer-executable instructions as well as a plurality of MOSFETs electrically coupled to the microprocessor(s) via their gates that switch on and off. One example of the matrix converter is disclosed in U.S. patent application Ser. No. 18/197,539 having the title “Seven-Switch Indirect Matrix Converter,” the entire contents of which are incorporated by reference. The control system 18 can include a digital signal processor (DSP) for carrying out the method steps disclosed here.

An electrical cable 22 can detachably connect with an electrical receptacle on the BEV 14 and electrically link a BEV charging station with the BEV 14 so that DC electrical power can be transmitted between the charging station and the BEV 14. The BEV charging station can be classified as “Level 3” BEV service equipment that receives AC electrical power from the grid 12 and supplies DC electrical power to the BEV 14.

The term “battery electric vehicle” or “BEV” can refer to vehicles that are propelled, either wholly or partially, by rotating electrical machines or motors. BEV can refer to electric vehicles, plug-in electric vehicles, hybrid-electric vehicles, and battery powered vehicles. The vehicle battery 24 can supply DC electrical power, that has been converted into AC electrical power, to the electrical machine(s) 16 that propel the BEV. The vehicle battery 24 or batteries are rechargeable and can include lead-acid batteries, nickel cadmium (NiCd), nickel metal hydride, lithium-ion, and lithium polymer batteries, to name a few. A typical range of BEV battery voltages can range from 200 to 800V of DC electrical power (VDC).

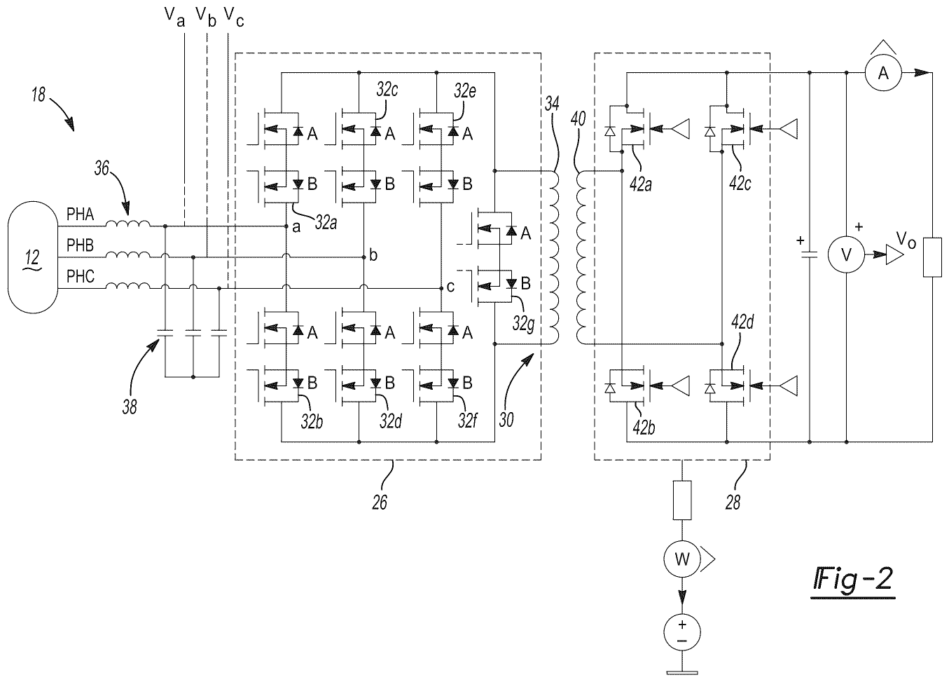

FIG. 2 depicts an implementation of a portion of the control system 18 used with the DC fast charger 20. The control system 18 includes an indirect matrix converter having a primary circuit 26 and a secondary circuit 28 inductively coupled together via a transformer 30. The primary circuit 26 can also be referred to as a primary group of switches whereas the secondary circuit 28 can also be referred to as a secondary group of switches. The primary circuit 26 includes seven switches 32 electrically coupled to the grid 12 and a primary winding 34 of the transformer 30. However, it should be appreciated that the primary circuit 26 can be implemented differently using a smaller quantity of switches, such as six switches. The switches 32 can be implemented using bipolar junction transistors (BJTs) or field effect transistors (FETs), such as insulated gate bipolar transistors (IGBTs), metal-oxide semiconductor field effect transistors (MOSFETs), or gallium nitride transistors (GaN). The switches 32 can be bidirectional or reverse-blocking such that they are four-quadrant switches capable of conducting positive or negative on-state current and blocking positive or negative off-state voltage. A number of different circuit configurations can be used to implement such a switch, any of which could be implemented in the DC fast charger described herein. In one implementation, each switch 32 includes an A side MOSFET and a B side MOSFET with gates that can be electrically connected to the control system 18. Six switches 32a-f can be electrically coupled to three legs of the electrical grid PHA, PHB, PHC and nodes a, b, c of the primary circuit 26. Voltages of these three legs can be identified as Vₐ, V_{b}, and V_{c}. A seventh switch 32g can be wired in parallel with switches 32e and 32f, and with the primary winding 34 of the transformer 30. Inductors 36 and line filter capacitance 38 can be electrically connected to the legs PHA, PHB, PHC of the grid 12.

The secondary circuit 28 is electrically connected to a secondary winding 40 of the transformer 30. The circuit 28 includes four switches 42a-d. The switches 42 can be implemented using bipolar junction transistor or field effect transistors (FETs), such as insulated gate bipolar transistors (IGBTs) metal-oxide-semiconductor field effect transistors (MOSFETs). The BEV battery 24 can be electrically connected to the switches 42a-42d such that the secondary circuit 28 rectifies AC voltage induced through the secondary winding 40 into DC voltage applied to the BEV battery 24. The control system 18 can be implemented using a microprocessor having outputs electrically connected to the gates of the switches 32, 42 in the DC fast charger 20.

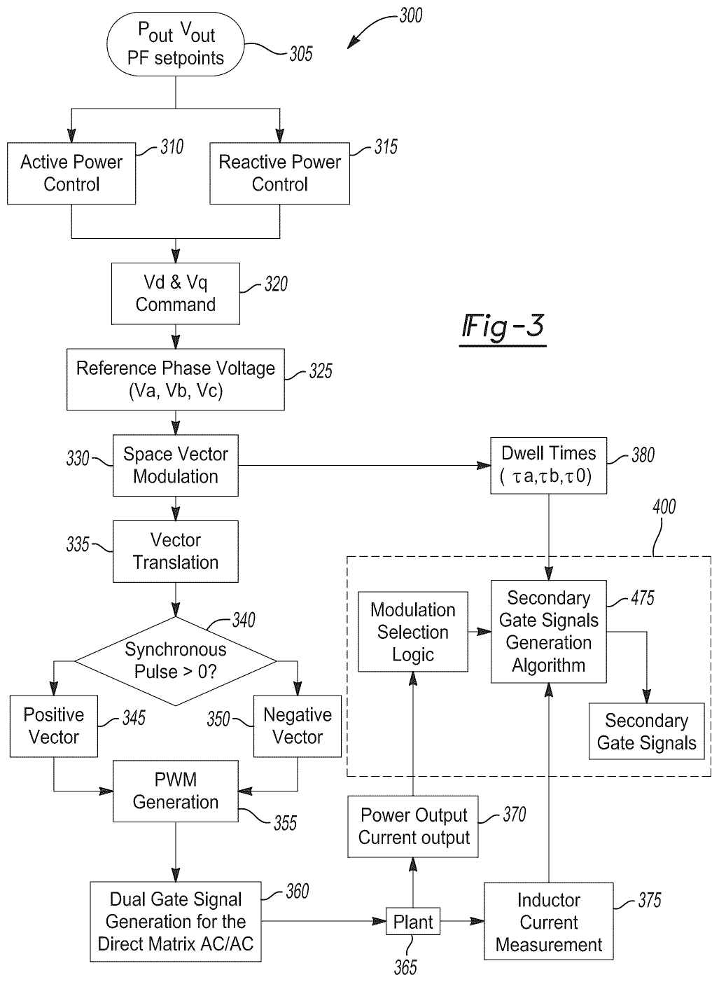

An implementation of a method 300 of operating the control system 18 is shown in FIG. 3. More specifically, the method 300 describes a number of steps for controlling the primary circuit 26 and the secondary circuit 28. The method 300 begins at step 305 by determining desired voltage (Vₒᵤₜ) and power (Pₒᵤₜ) set points. The method 300 then selects an active control scheme at step 310 and a reactive control scheme at step 315. The method 300 proceeds to step 320 where Vₐ and Vₐ commands can be generated. At step 325, a reference phase voltage can be determined (Vₐ, V_{b}, V_{c}). The method 300 proceeds to step 330 to carry out Space Vector Modulation (SVM). As part of the SVM, dwell times can be created at step 380 that can be used to control the switches 42 of the secondary circuit 28. The method 300 proceeds to step 335 where vectors are created and then step 340 to determine whether the synchronous pulse is greater than zero. If the synchronous pulse is greater than zero, the method 300 proceeds to step 345 and a positive vector can be generated; otherwise, the method 300 proceeds to step 350 and a negative vector can be generated. At step 355, pulse width modulation can be used to generate a signal and at step 360, gate signals can be generated and provided to the gates of switches 32 in the primary circuit 26. At step 365, the method 300 determines the state of the primary circuit 26 at the plant. The electrical power and current can be measured at steps 370 and 375, respectively, from the plant. The electrical power output, current output at step 370, and inductor current measurements at step 375 can be made from a plant at step 365. The method 300 proceeds to method 400 involving control of the secondary circuit 28.

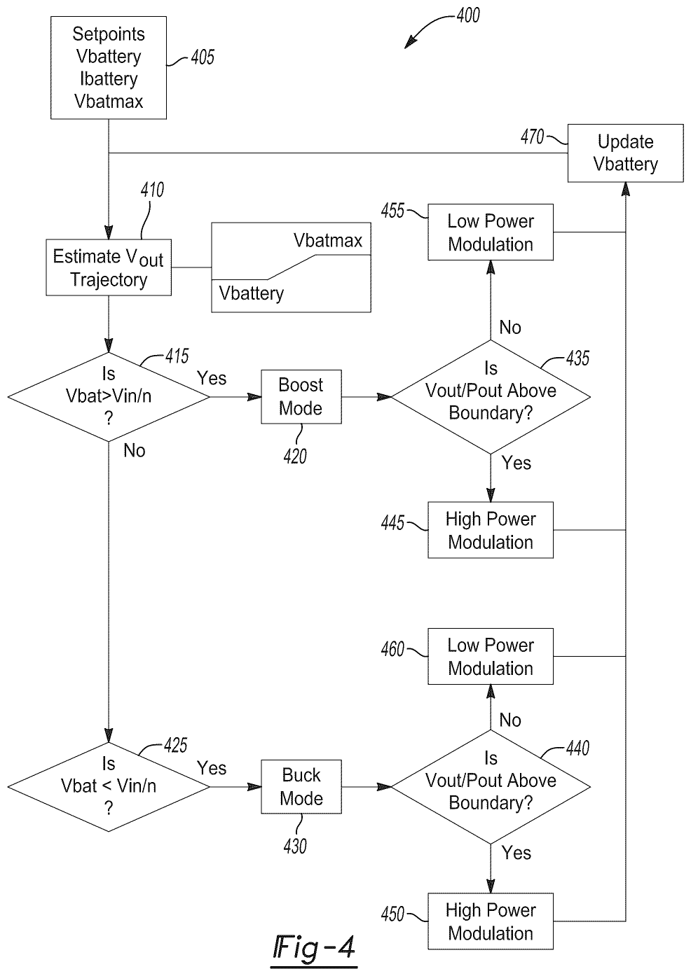

A flow chart is shown in FIG. 4 depicting a method 400 of controlling the secondary circuit 28. The method 400 relates to controlling a secondary duty cycle and phase shift of the secondary group of switches 42 included in the secondary circuit 28. The method 400 begins at step 405 by determining voltage and current set points for the vehicle battery 24. The method 400 then estimates a change in voltage to determine Vₒᵤₜ at step 410. The method 400 proceeds to step 415 and determines whether the voltage of the vehicle battery 24 is greater than the voltage Vᵢₙ applied to the primary circuit 26 divided by the turns ratio (n) of the transformer 30. If the voltage of the vehicle battery 24 is greater than the voltage Vᵢₙ applied to the primary circuit 26 divided by the turns ratio (n) of the transformer 30, then the method 400 proceeds to step 420 and the control system selects a boost mode at step 425. Otherwise, the method 400 performs step 425 and determines whether the voltage of the vehicle battery 24 is less than the voltage Vᵢₙ applied to the primary circuit 26 divided by the turns ratio (n) of the transformer 30. If the voltage of the vehicle battery 24 is less than the voltage Vᵢₙ applied to the primary circuit 26 divided by the turns ratio (n) of the transformer 30, then the method 400 proceeds to step 430 and the control system 18 selects a buck mode. Within the boost mode or the buck mode, the control system 18 can determine whether a particular combination of voltage (Vₒᵤₜ) to power (Pₒᵤₜ) is above or below a determined boundary curve at steps 435 and 440. The control system 18 can maintain a database of lookup tables in memory to determine values along the operation curve based on different electrical power and voltage values. If the existing voltage and power values are determined by the control system 18 to fall above the boundary curve, the method 400 can proceed to steps 445 or 450 to select high power modulation. On the other hand, if the existing voltage and power values are determined by the control system 18 to fall below the boundary curve, the method 400 can proceed to steps 455 or 460 to select low power modulation. The method 400 proceeds to step 470 and the amount of voltage applied to the vehicle battery 24 can be set. The method 400 can then generate gate signals for the switches 42 at step 475; the method 400 ends and returns to method 300.

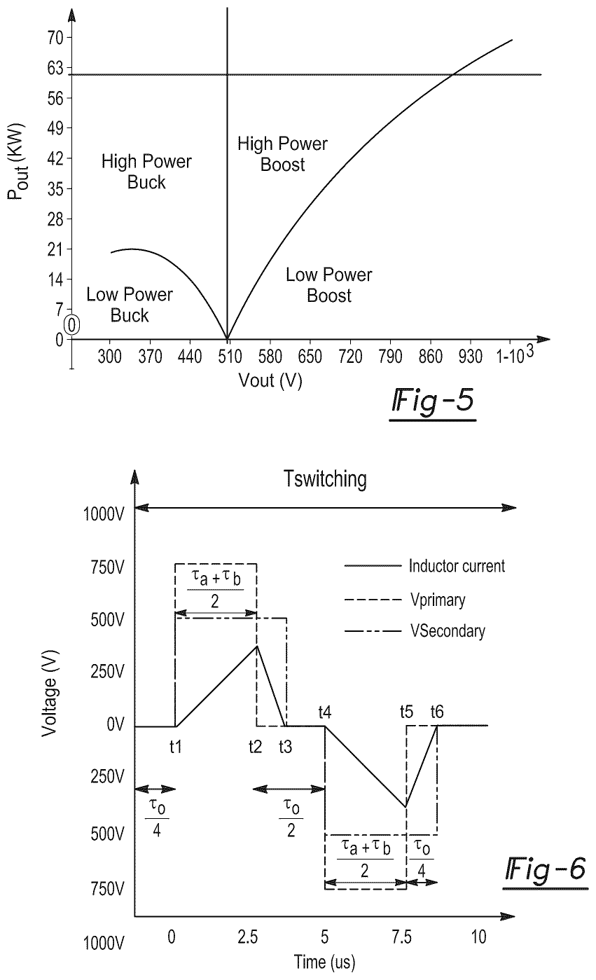

Turning to FIGS. 5-8, an implementation of the methods described herein is shown. The control system 18 can generate gate signals to the switches 42 in the secondary circuit selecting from four modes: high power buck, low power buck, high power boost, or low power boost. Given an environment in which Vᵢₙ to the primary circuit 26 equals 650 V, and turns ratio (n) of the transformer 30 equals 9/7, the control system 18 can determine an operational region based on different desired power (kilowatt (kW)) and Vₒᵤₜ values as is shown in FIG. 5. The operational curve plots Vₒᵤₜ versus Pₒᵤₜ with the curve indicating the boundary between low power and high power modulation. low power modulation can be performed on the region below the curve whereas high power modulation is performed in the region above the curve. Both low power and high power modulation can be performed on the boundary line. The maximum power delivered by the low power modulation can correspond to the minimum power delivered by high power modulation. For example, operating the secondary circuit 28 modulated using the low power modulation will deliver OW on the output at 505 V, which is the border between buck mode and boost mode.

Turning to FIG. 6, a graph depicting a measurement of voltage over time is shown while the secondary circuit 28 is operated using low power modulation in buck mode. Low power modulation in buck mode can be used when Vᵢₙ is greater than Vₒᵤₜ multiplied by the turns ratio (n) of the transformer 30 and the power is below the boundary curve. Inductor current levels can rise until t2 at which time voltage at the primary circuit 26 is turned off. Current falls after t2 until it reaches zero at t3 at which time voltage at the secondary circuit 28 is turned off. The switching sequence can be repeated for the negative part of the waveform to complete one switching cycle, Tswitching.

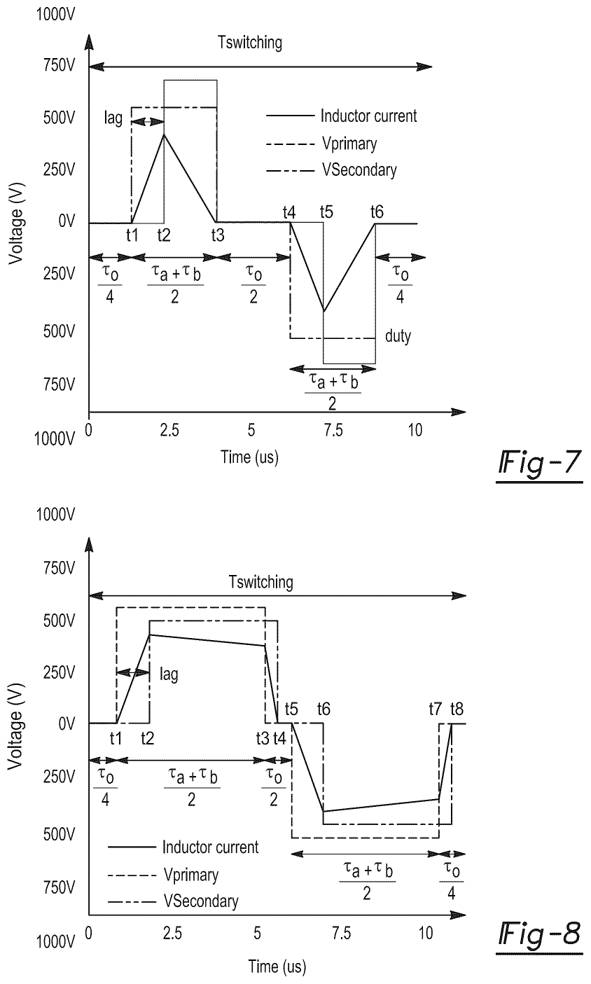

FIG. 7 depicts a graph of voltage over time while the secondary circuit 28 is operated using low power modulation in boost mode. Low power modulation in boost mode can be used when Vᵢₙ is less than Vₒᵤₜ multiplied by the turns ratio (n) of the transformer 30 and the power is below the boundary curve. The inductor current rises until t2 and afterwards an increased voltage at the secondary circuit 28 can be applied to an AC link, reducing the inductor current until it reaches zero at t3. From t3 to t4 no current flows and the switching sequence can be repeated for the negative part of the waveform (t4-t6) to complete one switching cycle, Tswitching.

FIG. 8 depicts a graph of voltage and current over time while the secondary circuit 28 is operated using high power modulation. The inductor current is rising between t1 and t2, then the current is either falling or rising between t2 and t3 depending on the input voltage (Vᵢₙ) and output voltage (Vₒᵤₜ) multiplied by the turns ratio (n) of the transformer 30. The inductor current then is falling between t3 and t4. Current does not flow between t4 and t5, which can be a period for turning off switches 42. The sequence can be repeated for the negative part of the waveform to complete one switching cycle, Tswitching.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A method of controlling power supply equipment, comprising the steps of:
(a) receiving alternating current (AC) electrical power at the power supply equipment;
(b) selecting a mode from the following possible modes: high power buck, high power boost, low power buck, or low power boost;
(c) generating gate signals based on the selected mode; and
(d) providing the generated gate signals to switches included in the power supply equipment that rectify alternating current (AC) into direct current (DC).

2. The method recited in claim 1, further comprising the step of determining a gain value and generating an operation curve using the gain value.

3. The method recited in claim 1, wherein the power supply equipment is a DC fast charger.

4. The method recited in claim 1, wherein the power supply equipment includes a matrix converter.

5. The method recited in claim 1, further comprising the step of receiving gate timing at the switches from space vector modulation.

6. A method of controlling power supply equipment, comprising the steps of:
(a) receiving alternating current (AC) electrical power at a primary group of switches of the power supply equipment that is electrically coupled to a primary wire of a transformer;
(b) determining a gain value;
(c) determining an operating curve based on the gain value;
(e) selecting a mode from the following possible modes: high power buck, high power boost, low power buck, or low power boost using an AC voltage value input at the primary circuit; and
(f) controlling a secondary group of switches based on the selected mode.

7. The method recited in claim 6, wherein the power supply equipment is a DC fast charger.

8. The method recited in claim 6, wherein the power supply equipment includes a matrix converter comprising the primary circuit and a secondary circuit electrically coupled via a transformer.

9. The method recited in claim 8, further comprising the step of receiving gate timing at switches in the secondary circuit from space vector modulation.

10. A control system for controlling power supply equipment, the system comprising:
a plurality of switches included with the power supply equipment; and
one or more microprocessors, including memory storing computer executable instructions, wherein the one or more microprocessors are configured to control the plurality of switches to receive alternating current (AC) electrical power at the power supply equipment; select a mode from the following possible modes: high power buck, high power boost, low power buck, or low power boost; generate gate signals based on the selected mode; and provide the generated gate signals to the switches that rectify alternating current (AC) into direct current (DC).

11. The control system recited in claim 10, wherein the one or more microprocessors determine a gain value and generate an operation curve using the gain value.

12. The method recited in claim 10, wherein the power supply equipment further comprises a DC fast charger.

13. The method recited in claim 12, wherein the DC fast charger includes a matrix converter.

14. The method recited in claim 10, further comprising wherein the switches receive gate timing from space vector modulation.
